(19) United States
(12) Patent Application Publication
(10) Pub. No.: US 2005/0007896 A1
(43) Pub. Date: Jan. 13, 2005

(54) Multiple compact disk storage, recording and playback system

(76) Inventor: Rodney Haas, SamutPrakarn (TH)

Correspondence Address: CHARLES G. CALL, 68 HORSE POND ROAD, WEST YARMOUTH, MA, 02673-2516, US

(21) Appl. No.: 10/807,951

(22) Filed: Mar. 24, 2004

Related U.S. Application Data
(60) Provisional application No. 60/457,186, filed on Mar. 25, 2003.

(51) Int. Cl. G11B 7/085

(52) U.S. Cl. 369/30.6; 369/30.48

(57) ABSTRACT

A CD changer consisting of a disk storage unit, two standard disk drives with extendable access trays, and a disk transport mechanism for moving individual disks between either access tray and a selected storage location in a warehouse where disks are densely stored in side-by-side vertical stacks above the two disk drives. A disk carrier mechanism moves each disk between a selected storage location and a transfer location positioned above an extended access tray of one of the drives. The disk carrier moves each disk vertically between the transfer location and an intermediate location horizontally aligned with the selected storage location, and moves the disk horizontally between the intermediate position and the transfer location.

### CROSS REFERENCE TO A RELATED APPLICATION

This application claims the benefit of the filing date of U.S. Provisional Patent Application Serial No. 60/457,186 filed Mar. 25, 2003, the disclosure of which is incorporated herein by reference.

### FIELD OF THE INVENTION

This invention relates to compact disk storage, recording and playback systems.

### BACKGROUND OF THE INVENTION

A compact disc (or CD) is an optical disc storing digital data. Originally developed to store digital audio, it is also used as a data storage device. More recently, the higher capacity Digital Versatile Disk (DVD) has been introduced and is capable of storing a complete movie on a single disk. As used in this specification, the terms “compact disk” and “CD” will be used to refer to CD and DVD disks of all types, including the “read only” disks identified by the initials CD-ROM and DVD-ROM as well as writable disks onto which data can be written, including the CD-R, CD-RW, DVD-R, DVD-RW, DVD+R, and DVD+RW disks.

Compact disks are used to store audio and video programming and for persistent data storage. One or more “drives” for reading and writing compact disks are frequently included as a component in personal computers. Compact discs are typically made from a 1.2 mm thick disc of polycarbonate plastic coated with a much thinner aluminum layer which is protected by a film of lacquer. CDs are available in a range of sizes but the most commonly available is 120 mm in diameter. The information on a standard CD is encoded as a spiral track of pits which is read reflecting light from a laser off the pits in the track. CD-R discs, which can be recorded by a laser beam using a CD-R writer (most often on computer, can be played on most compact disc players. CD-R recordings are permanent and cannot be recorded more than once, so the process is also called “burning” a CD. CD-RW is a medium that allows multiple recordings on the same disc over and over again. A CD-RW does not have as great a difference in the reflectivity of lands and bumps as a pressed CD or a CD-R, so many CD audio players cannot read CD-RW discs, although the majority of standalone DVD players can. For drives installed in computers, all current CD-ROM and DVD-ROM drives can read and write CD-R and CD-RW discs. Drives capable of writing to DVD disks can typically read CD-ROM disks and write to CD-R and CD-RW disks as well.

Compact disks have become the de facto standard for persistent, portable storage of audio, video (including movies), image and data storage. Personal computers are commonly equipped with one or more internal or external drives used to record or reproduce (play) information on a disk. CD drives are typically connected to the computer via a standard interface, and external drives are normally connected using a USB, Firewire, or SCSI cable. Both internal and external CD drives typically include a disk access tray, which is moved outward for the removal or installation of a disk, and returned inward so that information on the disk can be read. The drive also includes a spindle motor, which rotates the disk when it is installed within the drive, and an actuator motor that moves an optical arrangement in a radial direction relative to the disk to accomplish the sequential reading of information on the compact disk. The movement of the disk handling tray is typically provided through the use of motor driven mechanical drive, which may also be used to drive the disk to read or write data stored on the disk as described, for example, in U.S. Pat. No. 5,563,865 entitled “Compact disk transport tray moved by a disk reading mechanism issued to Arthur R. Wheeler (I.B.M.) on Oct. 8, 1996, the disclosure of which is incorporated herein by reference.

Conventional internal and external CD drives handle one disk at a time, and require manipulation by the human operator to mount and dismount a disk for reproduction and/or playback. Disk “changers” which are able to automatically select a disk from a small number of disks have been widely sold, and include “carousel” devices in which three to six disks are mounted on the same turntable that is rotated to position one of the disks in a playback position, and “magazine” devices often used in players for automobiles in which a group of disks is placed in a magazine and a transport device is used to extract a selected disk from the magazine, move it to a mounted position for playback and then return the disk to the magazine before a different disk is mounted. Disk changers of this type are described in U.S. Pat. No. 5,828,647 entitled “Disk changer with reduced driving time” issued to Young-Wong Lee et al. (Samsung Electronics) on Oct. 27, 1998 and U.S. Pat. No. 6,628,600 entitled “Disc change” which issued to Hideo Ito et al. (Pioneer Electronics) on Sep. 30, 2003, the disclosures of which are incorporated herein by reference. Each of these units stores only a limited number of disks and includes only one playback unit.

As used herein, the terms “drive” and “player” will be used to refer to compact disk mechanisms which handle one disk at a time whereas the term “changer” refers to mechanism store a collection of disks and include the ability to automatically select and mount an individual disk from that collection for reproduction or recording.

There is a need for a disk changer that can rapidly mount a selected disk from a large number of stored disks, that includes more than one playback units to permit (1) simultaneous recording and/or playback of more than one disk at the same time, (2) premounting of the next disk in a sequence on a drive other than the currently active drive so that substantially continuous playback or recording can be provided without a delay while disks are changed, (3) performing disk duplication without continuous attention from an operator, (4) automatically archiving of large quantities of information on multiple disks, and (5) performing other functions which cannot be efficiently performed with existing disk changers.

The preferred changer should be capable of storing and accessing a large number of CD's in a limited space, should access specified disks with reduced access times, should be easy to manufacture at low cost, should be highly reliable, and should be easy to use.

### SUMMARY OF THE INVENTION

The present invention takes the form of a CD changer consisting of storage unit for supporting a large number of CDs in one or more vertical stacks, one or more conventional disk drives each consisting of a housing and an extendable CD access tray for transporting an individual CD between a mounted operating position within the drive housing and an extended position outside the housing, a lifting mechanism for moving an individual CD between the access tray of each drive and an intermediate transfer positioned above the extended transfer tray(s). A disk carrier moves a CD between the intermediate transfer location and a given storage location within one of said stacks in the storage unit.

The preferred embodiment of the invention may by used as a peripheral storage, recording and playback device that connects via a conventional interface, such as a USB or Firewire connection, to a conventional personal computer. It may be used to automatically perform a number of useful functions without attention from an operator, including the continuous playback audio or video programming from multiple disk volumes, the duplication of information stored on one or more source disks or some other available source onto one or more destination disks, the backup of data stored on the computer's hard disk onto one or more compact disks, and other functions.

These and other features and advantages of the present invention will be more clearly understood by considering the following description of a simplified illustration of the invention and a detailed description of a specific embodiment. In the course of this description, frequent reference will be made to the attached drawings.

### BRIEF DESCRIPTION OF THE DRAWINGS

FIG. 1 is perspective view of a simplified disk changer mechanism in which disks are stored in a single stack;

FIGS. 2-7 are elevational views of the simplified changer of FIG. 1 illustrating the manner in which disks are moved between the storage unit and the individual drives;

FIG. 8 is a front elevational view of the preferred disk changer;

FIG. 9 is an enlarged perspective view of the CD lift mechanism and the two CD drives; and

FIGS. 10 and 11 are perspective views looking downward from the front and rear of the transfer tray and the two CD racks;

FIG. 12 is a close-up perspective view of the disk retention mechanism in the transfer tray; and

FIGS. 13 is an elevational view of the transfer tray vertical drive mechanism; and

FIGS. 14-16 are perspective views of the motor and solenoid operated drive gears in the transfer tray vertical drive mechanism.

### DETAILED DESCRIPTION

Introduction

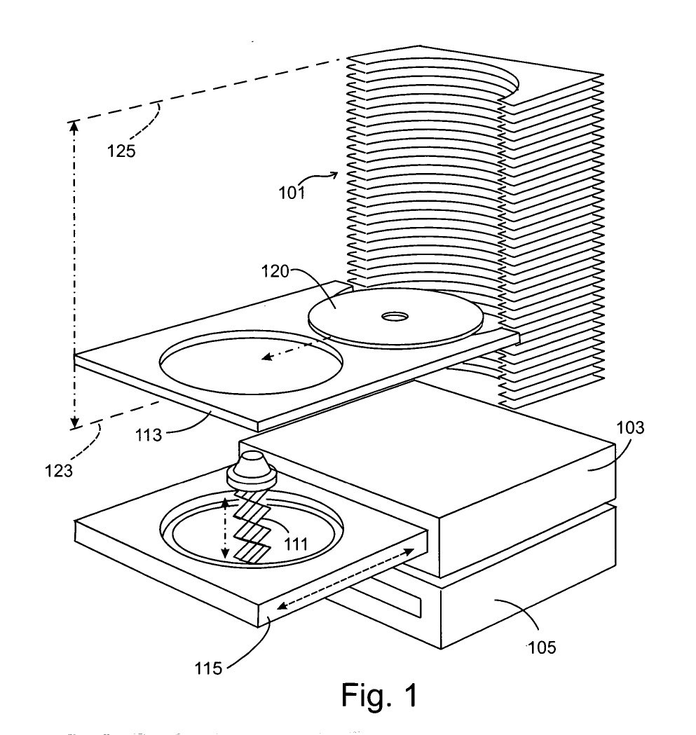

In the description that follows, a simplified changer as shown in FIGS. 1-7 will be described as an introductory explanation of the manner in which compact disks are automatically manipulated. Thereafter, a more detailed description of a preferred embodiment of the invention will be presented. Finally, a discussion of typical functions that may be performed using the changer will be presented.

As seen in FIG. 1, the changer consists of a storage unit 101, two standard disk drives 103 and 105, and a disk transport mechanism comprising a vertical lifter 111 and a transfer tray 113. The lifter 111 passes through the disk access tray 115 of the drive 103 which is shown in its extended position. A compact disk is seen at 120 on the transfer tray 113.

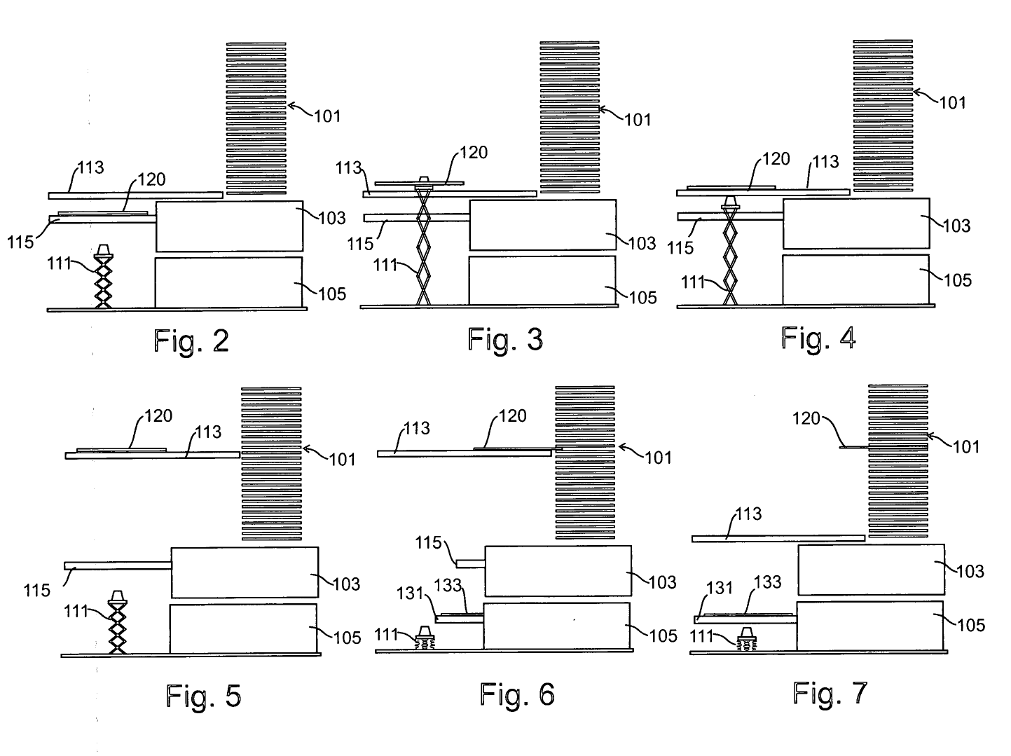

The storage unit 101 consists of vertically stacked shelves, each of which receives as supports an individual compact disk. A selected disk may be moved between the interior of one of the standard drives 103 and 105 in a three-phase process illustrated in FIGS. 2-7 which shows the movement of the disk 120 from the access tray 115 of the upper drive 103 (as seen in FIG. 2) to a stored position in the storage unit 101 as seen in FIG. 7.

In the first phase of the transfer, an “eject” command is sent to the upper drive 103, causing the access tray carrying the previously mounted disk 120 to it extended position seen in FIG. 2. The lifter 111 then moves upwardly, lifting the disk 120 to a position above the transfer tray 113 as seen in FIG. 3. The lifter then descends, dropping the disk 120 on the transfer tray which includes a disk catching mechanism (not shown) that allows the disk to pass upwardly through the tray 113 and then catches the disk when the lifter 111 is dropped as seen in FIG. 4.

The lifter 111 continues its descent to a point below the access tray 115 as seen in FIG. 5, permitting the access tray 115 to be retracted back into the drive 103 in response to a “tray close” command as seen in FIG. 6. At the same time, as also seen in FIG. 6, the access tray 131 carrying a second disk 133 from the lower drive 105 extends in response to an “eject” command. While the two access trays are in motion, the transfer tray 113 moves upwardly until it upper surface is level with a selected shelf in the storage unit 120, and the disk 120 is then urged (by a mechanism not shown in FIGS. 1-7) onto the shelf as seen in FIG. 6.

After the disk 120 has been moved into the storage unit, the transfer tray moves downwardly to return to its home position as seen in FIG. 7, and the disk 133 may then be lifted from the access tray 131 on the lower drive 105 to begin the transfer process shown in FIGS. 2-7 for the disk 120.

The reverse process is followed for moving a selected disk from the storage unit 101 to a mounted position within one of the drives 103 or 105. The empty access tray of the drive which is to receive the disk is ejected to its extended position. At the same time, the upper surface of the transfer tray 115 moves to the level of the shelf holding the desired disk. The disk is then urged off the shelf and onto a position on the transfer tray centered above the lifter 111, and the transfer tray then drops to its lowered home position. The lifter 111 rises to lift the disk off the transfer tray 1 15, and then descends to drop the disk onto the extended drive access tray, which is then retracted into the drive to begin recording or playback.

From the foregoing description, several advantages provided by the changer are apparent. The system uses standard CD drives with standard access trays and standard interfaces to the computer system, thereby reducing costs. The storage unit is easily fabricated from multiple standard shelf units. By stacking drive units, a single lift mechanism can serve more than one drive. The lifting mechanism, the access trays on the drives, and the transfer tray may all move independently, permitting different operations to be performed at the same time, and thus shortening the access and storage times required for disk handling. Finally, as seen in the description to follow, the access tray may serve more than one stack of disks, providing even greater disk storage capacity.

Changer Subsystems

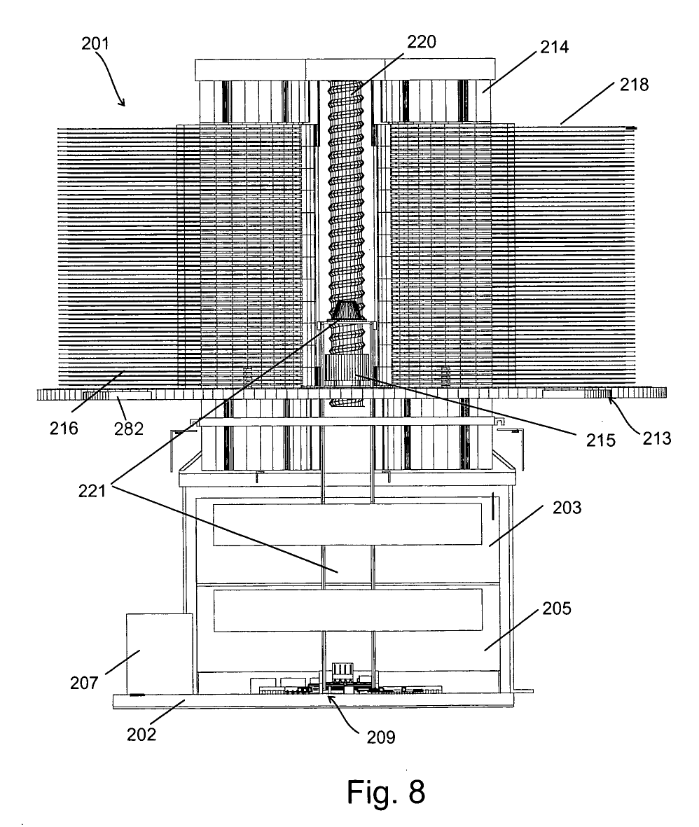

The preferred embodiment of the invention shown in FIGS. 8-16 is a CD changer made up of the following principle subsystems:
(a) a disk storage unit in which a collection of compact disks can be stored vertically in a closely spaced stack, thus allowing a large number of CD's to be housed in a small space;
(b) a playback and/or recording system preferably comprising two or more standard disk drive units for reproducing and recording information on selected compact disks;
(c) a transport mechanism for moving any selected disk quickly and accurately between a specified location in the storage unit and a playback/recording position in a selected player;
(d) a standard interface, such as a USB or Firewire connection, that allows the standalone unit to communicate with an external computer;
(e) a power supply capable of powering the players and the transport mechanism;

(f) means enabling a user to easily load and unload CDs into and out of the disk storage unit; and
(g) software executable on the connected computer for controlling the changer and managing the content and location of the CDs in the storage unit.
   Changer Components

As shown in FIG. 8, the main structural components of the changer are a storage unit indicated generally at 201 which is positioned above a base 202 that supports an upper disk drive unit 203 stacked above a lower disk drive unit 205. The disk drive 203 is loaded and unloaded via a CD access tray 204, and a similar access tray 206 is used to load and unload the lower drive 205. A power supply at 207 is also mounted on the base 202 and provides operating potentials for the two disk drives as well as the electronic interface components mounted on a circuit board indicated at 209. A CD lift mechanism indicated 211 is also mounted on the base 202 and is used to move CDs to and from the access trays 204 and 205.

The storage unit 201 is supported on a storage support base 210 upon which an insert tray 212 and a main transfer tray indicated generally at 213 are supported. Two shelf racks 216 and 218 are attached to a mounting frame 214 which extends upwardly from the storage unit base 210. The base 210 and the mounting frame 214 support the ends of a threaded vertical shaft 220 which engages with the lead nut 222 in the transfer tray 213. The threaded shaft 220 is rotated by a gear mechanism described below to move the transfer tray 213 vertically.

The two standard, rack-mounted internal IDE CD drive systems seen at 203 and 205 can be chosen from a variety read only or writeable CD or DVD drives to meet the needs of the user. The power supply at 207 provides power for these drives and to the electronic interface circuitry on the board 209 which transfers data and commands between the standard IDE connection to the drives and a USB 2.0 and Firewire connection to an external computer.

Lift Mechanism

The CD lift mechanism 211 is also located in the base unit as seen in FIG. 8 at 211. The lift mechanism 211 is a small-scale scissor lift of the type used in material handling applications. The bottom-most lever is pushed and pulled horizontally via a motor running a small lead screw (not shown), thus extending and retracting the entire scissor mechanism vertically to raise and lower a frustoconical spindle 230. The scissor lift mechanism minimizes the overall height of the complete changer, allowing the lift mechanism to fit under the access tray of the lower drive without the need to substantially elevate the lower drive off the base of the changer. Alternative methods, such as a telescopic cylinder could be employed, but would add to the overall vertical height of the changer.

The spindle 230 is sized to fit into and engage with the circular center hole of a CD, and serves to align the CD as it is lifted into the center hole. This system lifts the CD vertically and requires only has two programmable positions: full up and full down. In between these positions are located four points where the CD can be captured. These four capture positions, in descending order, are defined by (1) the main transfer tray 213, (2) the insert tray 212, (3) the access tray 204 for the upper drive 203, and (4) the access tray 206 for the lower drive 205. Mechanisms to be described on the main transfer tray 213 and on the insert tray 212 may be positioned to either allow the CD to pass through that position, or be held. In the case of the CD drives, the CD access trays 204 and 206 are used as the capture feature and are retracted into the drive to allow a disk to pass through that position.

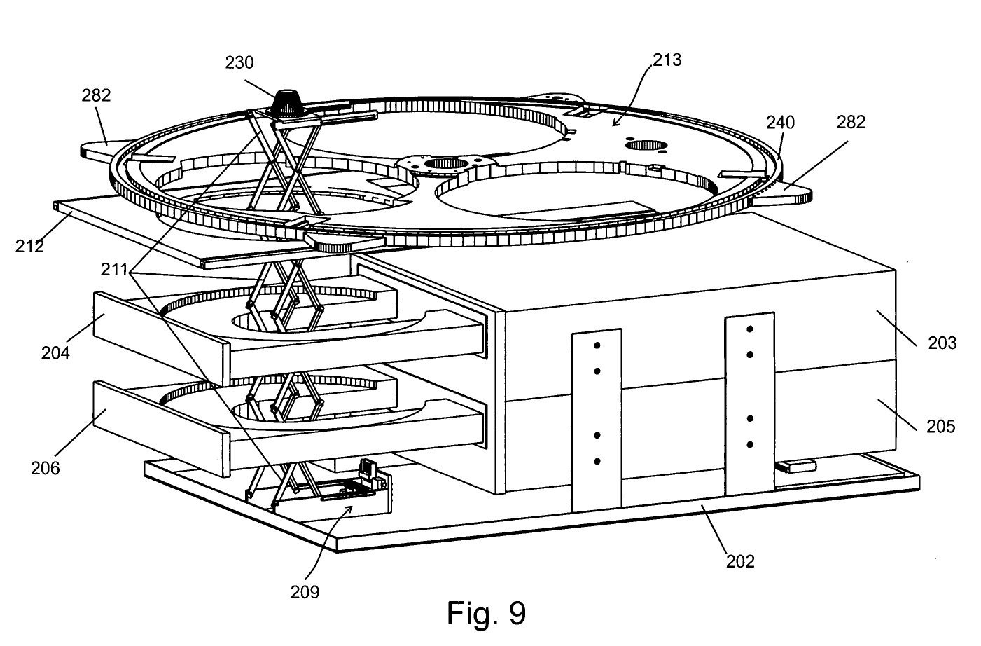

The manner in which disks are transported in the preferred embodiment of FIGS. 8-16 is essentially the same as that described above for the simplified arrangement seen in FIGS. 1-7, with the following principle exceptions:
(a) The preferred embodiment utilizes the “insert tray” 212 which enables the user to insert disks into and receive disks from the system. The insert tray 212 slides in a forward direction to extend outwardly from the changer's housing (not shown) to accept or deliver a disk, and slides inwardly to position an ingoing or outgoing disk directly above the lifting mechanism 211 in the position shown in FIG. 9. The insert tray has two retention arms similar to 260 on the main tray. These are normally open to allow the lift 213 to pass CD's directly thru to the CD's. This tray can be moved horizontally either by manual means or via a motor drive similar to drive doors found today in conventional CD player/writers.
(b) The disk storage unit holds two vertical arrays of shelves to hold two separate stacks of disks, thereby doubling the capacity of the changer without increasing its height. To serve these two stacks, a transfer tray 213, described in more detail below, is employed to move disks horizontally between a transfer position on the tray 213 positioned over and vertically aligned with the lifting mechanism 211 and a stored position in either the right or left disk stack. The transfer tray includes an outer ring 240 which rotates in a clockwise direction (viewed from the top) to move a CD from the transfer position above the lifter 211 into left storage rack 216, or rotates in a counterclockwise direction about the tray 213 to move a CD from the transfer position into the right hand rack 218.

Two examples of the operation of the changer are presented below.

Inserting a new CD for storage

1. The insert tray 212 is opened to receive a new CD.

2. The lift mechanism 211 is set to its fully down position.

3. The access trays for both CD drives 203 and 205 are closed.

4. The transfer tray 213 is set to full down position

5. Transfer tray retention is set to Open.

6. Operator inserts a CD and closes the insert tray 212.

7. A “store” command is issued to initiate the following sequence:

8. Lift mechanism 211 goes to full up, lifting the newly inserted disk off the insert tray 212 to a position above the transfer tray.

9. Transfer tray retention is set to Closed.

10. Lift mechanism 211 goes to full down, dropping the disk onto the transfer tray as it passes.

11. Transfer tray 213 is indexed vertically to the level of an open position on one of the stacks 216 or 218.

12. Transfer tray outer ring 240 is indexed either left or right to move the new disk into the open position on one of the stacks.

13. Transfer tray outer ring 240 sent home.

Loading a CD into the lower drive from storage location:

1. Lift mechanism 211 moved to its fully down position

2. Access tray of the lower drive 205 is opened

3. Transfer tray 213 is indexed vertically to the height of the desired CD.

4. Transfer tray 213 retention is set to unload

5. Transfer tray ring 240 is indexed either left or right to the stack holding the desired CD.

6. Transfer tray ring 240 sent home to position the CD over the lift mechanism 211.

7. Insert tray 212 retention is set to Open.

8. Transfer tray 213 is lowered to full down position.

9. Lift mechanism 211 sent up to lift the CD above the transfer tray 213.

10. Transfer tray 213 retention is set to open.

11. Lift mechanism 211 is dropped to lower position, dropping the CD onto the access tray 206 for lower drive 205.

12. Access tray 206 is closed to mount the CD for recording or playback on the drive 205.

From the two examples above it can be seen that, through the use of the retention features at each location, the CD can be shuttled up and down quickly, without the need for extensive sensing and robotic systems.

CD Storage Racks

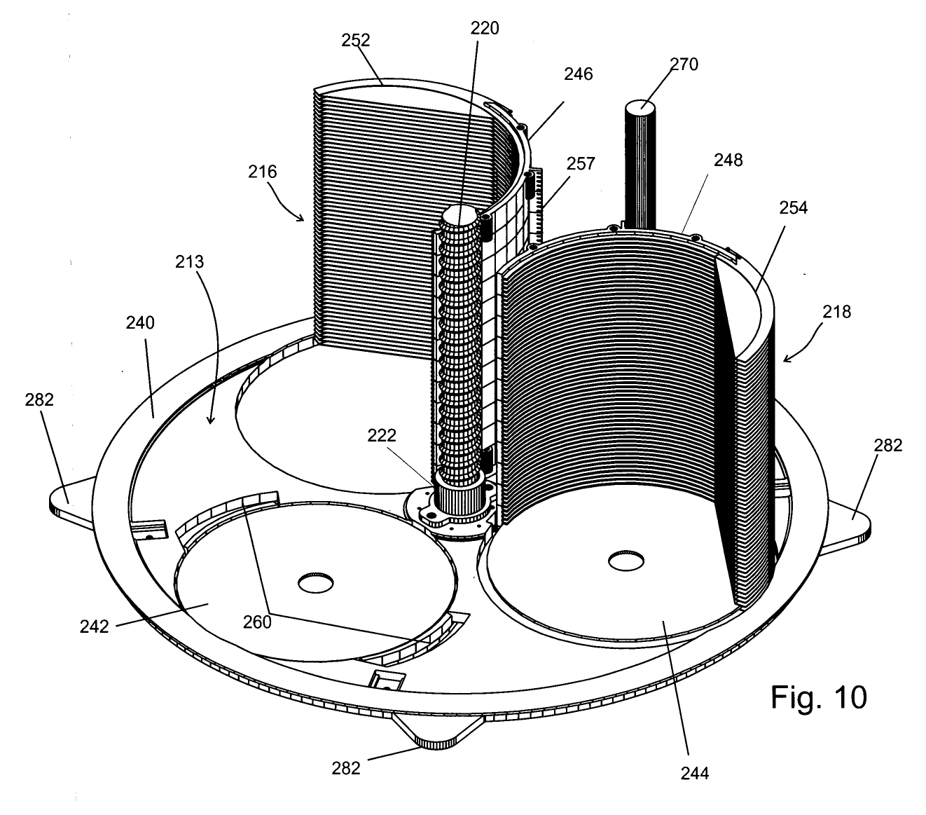

There are two racks indicated generally at 216 and 218 in FIG. 10 which are mirror images of each other. Both racks form an array of semicircular shelves positioned on either side of the transfer location at which, as shown in FIG. 10, a CD 242 is located. A second illustrative CD 244 is shown loaded onto the lowest shelf in the rack 218. The two racks allow dense storage of standard CD disk media. The pitch per CD is 0.085 inch. Each rack consists of an injection molded main housing seen at 246 for the rack 216 and at 248 for the rack 218. The interior surface of each of the main rack housings 246 and 248 defines an array of 60 slots, each of which receives and supports the edge of a CD. An array of thin metal extensions seen at 252 and 254 is attached to the side of the housings 246 and 248 respectively. Each extension provides shelf support for a CD further around its circumference, while allowing the CD to be moved into or out of the rack when carried by the ejector ring 240 which passes thru the open area above the metal extension. The CD racks are interconnected via pins which permit them to be stacked. A linear array of slots is incorporated into each housing. The slot array for the housing 246 is seen at 257. These slot arrays are used for detecting the vertical position of the tray 213 using a photointerupter as seen at 261. The slots 257 slots are molded into the rack housing 246 so that positive alignment between the tray and a chosen vertical level within the racks can always be accurately detected. Rack supports on the frame 214 (seen in FIG. 8) are located above and below the CD racks and provide vertical mounting to the upper and lower housing.

Main Tray system

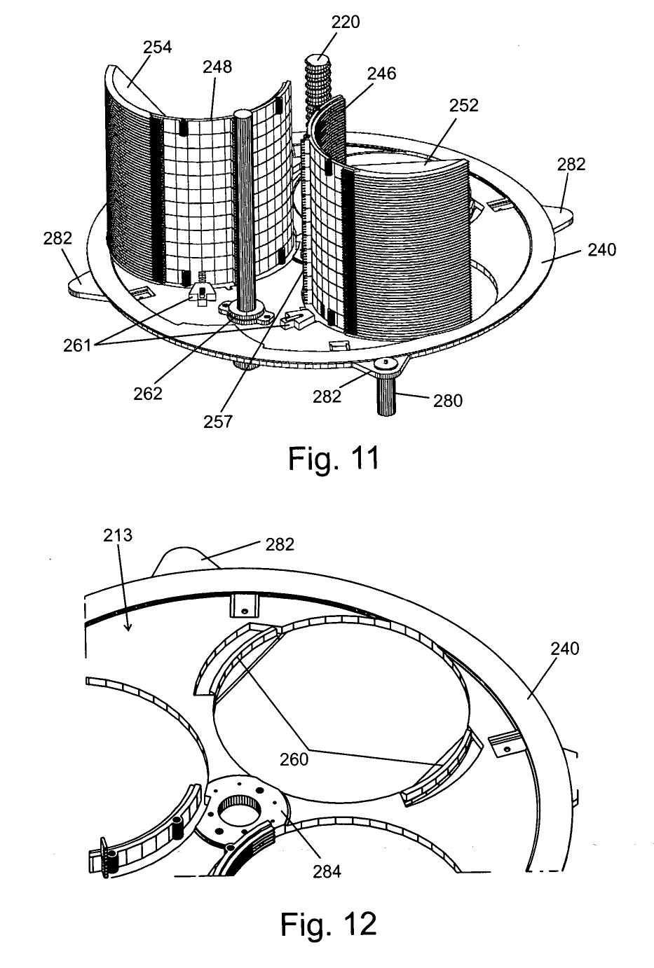

The tray system seen in perspective in FIGS. 10-12 contains the following main elements: the main transfer tray 213 which provides the structural support for the outer ejection ring 250 and a disk retention system seen at 260; and the main tray guide bushing 262 (seen in FIG. 11) and the drive nut 222. The guide bushing 262 slidably engages the support post 270 which extends between and is supported at its ends by the storage unit base 210 and the frame 214. The guide bushing 262 provides lateral stability of the tray unit while the captured drive nut 222 allows vertical movement of the tray when the tray lead screw 220 is turned.

Tray sensors

Tray location photointerrupters seen at 261, one for each rack, are positioned as seen in FIG. 11 to detect the tray's vertical location. Photointerruptor 261 counts the pulses generated via the rack slots at 257. Fine adjustment is also accomplished using the sensor to detect fine movement of the tray at the first trigger location of the sensor (the bottom of each slot). A CD detect photosensor (not shown) positioned adjacent each rack determines whether a CD is stored at the current location on that rack. The Ring Home sensor (not shown) detects the when the outer ring 250 is in its home position and a ring index sensor (not shown) determines its current location based on direction of movement from home by counting pulses. A CD retention sensor (not shown) indicates the position of the CD retention arms 260.

Eject Ring

This large ring seen at 240 rotates about the circumference of the tray 213 driven by a DC gear motor mounted to the tray and shown at 280 in FIG. 11. Three idler arms (not shown) provide bearing surface for the ring, while four retainers seen at 282 capture the ring 240 from above. The ring is designed to rotate a full 360 degrees around the tray. A CD push blade (not shown) extends inwardly from the ring 240 to engage with the outer edge of a CD and press it against a center bushing 284. This blade passes through the metal shelves 252 and 254 on the CD racks. Guide features in the tray keep the CD from extending upward. As the ring 240 rotates, the CD is pushed in a circular direction around the tray. The ring sensor determines the stop point for different operations. The push blade is used to push CD's into and out of both racks 216 and 218.

Tray Retention system

The retention arms 260 are located on the left and right sides of the tray eject opening at the home position of the tray. These arms have three positions. (1) Open, allowing the CD to pass thru unhindered; (2) Store, which sets the CD on top of the tray 213, allowing the ring blade to push the CD either left or right to its storage location in one of the racks 216 or 218, and (3) Eject, which, when the CD is pushed over the transfer opening at the home position, allows the CD to fall slightly into the transfer area where it is held for presentation to the lift mechanism 211. The tray retention system is operated with a DC motor and linear actuator (not shown).

Insertion Tray

The insertion tray seen at 212 in FIGS. 8 and 9 is a tray similar to one found on a standard CD drive. It allows CD's to be loaded into the storage unit, holding them in a known location for the lift mechanism 212 to access them for movement into a disk drive or into a selected storage rack.

Insertion Tray Retention System

Similar to the tray retention system on the main transfer tray 213, the insert tray 212 is also provided with a retention system that holds the CD while the door is open and also allows the CD to pass through the insert tray once it is in the closed position. This system is also operated with a DC motor and linear actuator (not shown).

Tray Vertical Drive Mechanism

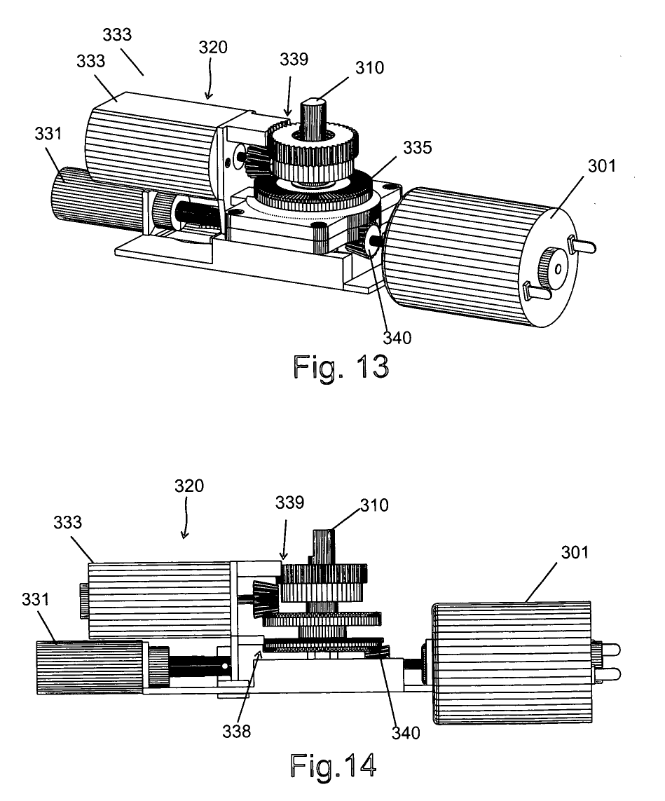

The mechanism for rapidly positioning the transfer tray 213 at the desired vertical location has four main components shown in FIGS. 13 and 14.

A fast drive motor 301 rotates the lead screw 220 (seen in FIGS. 8 and 11) to which the tray 213 is connected via the drive nut 222. The fast drive gear seen at 312 in FIG. 14, driven by the vertical drive motor 301, allows the tray to move rapidly over the full distance of the CD racks. As this drive system is work with systems holding 500 or more CDs, quick movement of the tray 213 is necessary to keep CD access time to a minimum.

The fine increment drive system indicated generally at 320 moves the entire tray 213 and the lead screw 220 vertically in small increments. The lead screw 220 fits over and is turned by the shaft 310 which is turned by the fast feed drive. By having two systems, fast tray movement can be accomplished via a very coarse pitch lead screw gearing at 312 for the tray, perhaps as coarse as 2 to 4 threads per inch. The tray is run quickly, counting the photointerrupter pulses. Once the correct pulse count is found, the fine increment system 320 moves the tray and lead screw downward until fine positioning photointerrupter detects that the desired vertical position has been reached. This insures the tray is at the exact location where the ring blade can pass thru the rack.

In order to keep the lead screw from turning while the fine increment is rotating, a fine adjust shuttle solenoid 331 is provided. This shuttle performs three tasks: (1) it engages the fine drive motor 333 to the fine drive gear 335, (2) locks the main drive bevel gear in place at 338 (FIG. 14), and finally (3) locks the fine lead nut in place at 339, but still allows vertical movement of the fine lead nut 335. Because the main lead screw must be allowed to move vertically, the fast drive bevel gear is captured in the drive gear housing. This housing provides a bearing surface for the drive bevel gear, and insures it maintains contact to the pinion gear 340, while at the same time allowing the main lead screw 220 which is turned by the shaft 310 to move vertically.

Applications

The system may be used to playback or record from selected disks in the storage unit. Multiple copies of one CD to be made by indexing blank CDs into a recording drive while reading from a playback drive or an external CD system, and then either ejecting these newly recorded CDs, or storing them again within the storage unit. Using the same method, the system may be used to back up large quantities of data onto a plurality of disks. The system may further be used to implement a system for video/audio content on a plurality of different disks using the system to perform for automatic indexing.

Conclusion

The specific embodiment of the invention that has been described is merely one illustrative application of the principals of the invention. Numerous modifications may be made to the specific apparatus and methods described without departing from the true spirit and scope of the invention.

1. A CD changer comprising, in combination,
a storage unit for supporting a collection of CDs in one or more vertical stacks,
a CD player comprising a housing and an movable CD access tray for transporting an individual CD between an operating location inside said housing and an extended location external to said housing,
a lifting mechanism for moving said individual CD between said extended location and a transfer location positioned above said extended location, and
a horizontal transport for moving said individual CD between said transfer location and a selected storage location within one of said stacks.

2. A CD changer as set forth in claim 1 wherein said transfer location is defined by a vertically movable disk carrier including vertical drive means for positioning said disk carrier at the same vertical level as said given storage level within one of said stacks.

3. A CD changer as set forth in claim 2 wherein said vertical transport comprises a CD lifting mechanism for lifting said individual CD from said extended location on said access tray to a position above said transfer location and then dropping said individual CD onto said disk carrier at said second transfer location.

4. A CD changer as set forth in claim 2 wherein said vertical transport comprises a CD lifting mechanism for lifting said individual CD from said transfer location defined by said disk carrier to a position above said transfer location and then dropping said individual CD through said second transfer location onto said access tray at said extended location.

5. A CD changer comprising, in combination,
a CD player comprising a housing and an movable CD access tray for moving an individual CD between an operating location inside said housing and an extended location external to said housing,
a lifting mechanism for moving an individual CD between said extended location and a transfer location positioned above said extended location, and
a disk storage unit for comprising, in combination:
one or more vertical arrays of disk storage shelves for supporting compact disks, and
a disk transport mechanism including a disk carrier for moving said individual CD between said transfer location and a selected one of said disk storage shelves.

6. A CD changer as set forth in claim 5 wherein said disk transport means comprises a mechanism for transporting said individual CD vertically between said transfer location and an intermediate location horizontally aligned with said selected one of said shelves and for transporting said individual CD horizontally between said intermediate position and said selected one of said shelves.

7. A CD changer as set forth in claim 5 wherein CD lifting mechanism moves said individual CD from said extended location to transfer location by lifting said CD above said transfer location and then dropping said individual CD onto disk carrier at said transfer location.

8. A CD changer as set forth in claim 7 wherein CD lifting mechanism moves said individual CD from said transfer location to said extended location by lifting said CD from said disk carrier at said transfer location to a position above said transfer location and then dropping said individual CD onto said access tray at said extended location.

9. A CD changer as set forth in claim 7 wherein said CD lifting mechanism comprises a set of scissor action levers driven at their lower end by an electric motor that separates and brings together said levers to lower and raise said lifting mechanism.

10. A CD changer as set forth in claim 7 wherein a frustoconical member at the top of said said lifting mechanism engages with and aligns the center opening of said individual CD.

11. A CD changer as set forth in claim 6 wherein said mechanism for transporting said individual CD vertically includes a two speed drive mechanism for first moving said individual CD rapidly to approximately a desired vertical level and then moving said individual CD at a slower rate to said intermediate location horizontally aligned with one of said shelves.
